(19) United States
(12) Patent Application Publication
(10) Pub. No.: US 2022/0236404 A1
(43) Pub. Date: Jul. 28, 2022

(54) DEVICE BASED POSITIONING RELYING ON TIMING MEASUREMENTS

(71) Applicant: Telefonaktiebolaget LM Ericsson (publ), Stockholm (SE)

(72) Inventors: Fredrik GUNNARSSON, Linköping (SE); Satyam DWIVEDI, Solna (SE); Per ERNSTRÖM, Stockholm (SE); Florent MUNIER, Västra Frölunda (SE); Ritesh SHREEVASTAV, Upplands Väsby (SE); Iana SIOMINA, Täby (SE)

(21) Appl. No.: 17/610,279

(22) PCT Filed: May 8, 2020
(86) PCT No.: PCT/IB2020/054378

§ 371 Date: Nov. 10, 2021

Related U.S. Application Data
(60) Provisional application No. 62/846,431, filed on May 10, 2019.

(51) Int. Cl. G01S 13/76; H04W 4/029; G01S 13/87

(52) U.S. Cl. CPC G01S 13/765; G01S 13/878; H04W 4/029

(57) ABSTRACT

A method and UE for determining a position of a UE is provided. Assistance data is obtained from a network node for determining the position of the UE at the UE. A round trip time (RTT) measurement procedure is performed with a serving cell base station to obtain a RTT measurement. A received time is measured of a DL PRS from one or more neighbor base stations. The position is estimated using the assistance data, the RTT measurement and the DL PRS received time. A method and a network node to provide the assistance data is also provided. Information indicative of a distance to each of one or more neighbor base stations of a serving cell base station of the UE and location information of the base stations is obtained. Assistance data is provided to the UE, including the information indicative of the distance and the location information.

### TECHNICAL FIELD

The present disclosure relates generally to communications, and more particularly to communication methods and related devices and nodes supporting wireless communications.

### BACKGROUND

Positioning has been a topic in LTE standardization since 3GPP Release 9. The primary objective is to fulfil regulatory requirements for emergency call positioning. Positioning in NR has been proposed to be supported by the architecture shown in FIG. 1. In FIG. 1, Note 1 is used to indicate that the gNB and ng-eNB may not always both be present. Note 2 is used to indicate that when both the gNB and ng-eNB are present, the NG-C interface is only present for one of them. The location management function (LMF) is the location server in NR. There are also interactions between the location server and the gNodeB via the New Radio Positioning Protocol A (NRPPa) protocol. The interactions between the gNodeB and the device is supported via the Radio Resource Control (RRC) protocol.

There are several measurement methods to enable the computation of a user's position in a network. These methods may make use of a reference signal either received by the user equipment (UE) (e.g., downlink reference signals), received by the network (e.g., uplink reference signals) or received by both the UE and the network. The measurements can thus be performed by the UE or by the network and be single-direction measurements (e.g., Time of Arrival (ToA) measurements or RSRP measurements) or bidirectional measurements (e.g., round trip time (RTT) or RxTx). Typically, a positioning algorithm is based on measurements concerning multiple cells.

In LTE, there is UE Rx-Tx time difference measurements and Timing Advance Type 1 and Type 2 measurements, which can be reported for E-CID (enhanced cell ID) positioning for the serving cell only. The Type 2 measurement is the Rx-Tx (receive-transmit) timing difference (positive or negative value) of radio frame #i at eNB, and the measurement relies on the timing advance estimated from receiving a PRACH preamble during the random access procedure. Type 1 is defined as the sum of the Rx-Tx timing difference of radio frame #i at the eNB and the Rx-Tx timing difference at the UE (always a positive value). The base station measures first its own timing difference and configures the UE to correct its uplink timing per Timing Advance (TA) command via medium access control (MAC). The UE may also measure and report UE Rx-Tx timing difference. Both timing differences allow the calculation of the Timing Advance Type 1, which is corresponding to the Round Trip Time (RTT) and where the distance d to the base station is calculated using d=c*RTT/2, where c is the speed of light.

The UE Rx-Tx may be calculated according to UE Rx-Tx=UE Rx−UE Tx (always positive in LTE, both Rx and Tx are for serving cell only). The Timing Advance Type 2 may be calculated according to Timing Advance Type 2=eNB Rx−eNB Tx (and can be positive or negative in LTE, both Rx and Tx are for serving cell only). The Timing Advance Type 1 may be calculated according to Timing Advance Type 1=(eNB Rx−eNB Tx)+(UE Rx−UE Tx).

Among the solutions for new radio (NR), time-based positioning solutions have attracted interest. The following methods have been discussed within the 3GPP standardization:

Downlink positioning:
Timing based techniques
   Timing of arrival path(s)
   Phase difference based techniques
      Note: feasibility needs to be further assessed
Angle-based techniques
   Downlink angle(s) of departure
   Downlink angle(s) of arrival
Carrier-phase based techniques
   Note: feasibility needs to be further assessed
Received reference signal power based techniques
Cell ID and TRP related information (e.g. RS resource and/or resource set ID)

UL positioning:
Timing based techniques
   Timing of arrival path(s)
Angle-based techniques
   Uplink angle(s) of departure
   Uplink angle(s) of arrival
Carrier-phase based techniques
   Note: feasibility needs to be further assessed
Received reference signal power based techniques

Downlink+Uplink:
Timing based techniques
   Round trip time measurement including support for multiple TRPs
Combination of DL and UL techniques for NR positioning
   e.g. E-CID like techniques (including one or multiple cells)
Combination of DL, UL and DL+UL techniques can be used for NR positioning
Combination of RAT-dependent and RAT-independent techniques can be considered for NR positioning

The positioning can be based on downlink and/or uplink positioning reference signals (PRSs). Essentially, the PRS can be an existing or newly introduced signal, and the term PRS may be used to describe a generic UL and/or DL signal used for positioning.

Typically, positioning which is relying on UE measurements can be categorized into:
UE-assisted, where the network configures the UE to perform and report positioning measurements to enable the network to estimate the UE position;
UE-based, where the network configures the UE to perform positioning measurements to enable the UE to estimate its position; and
Standalone, where the UE estimate its position without network assistance

The UE positioning is shown in FIG. 2, with 1 UE in a network with a number of base station (3—BS 1, BS 2, and BS3—are shown as example). Each base station coordinates set is known as (xi,yi), and the distance to be estimated between the UE and a base station is di.

### SUMMARY

According to some embodiments of inventive concepts, a position of a UE can be determined based on round trip transmission measurements without requiring signals in both directions between the same UE and each network node involved in determining position of the UE and may rely on asymmetric RTT measurements (e.g., measurements comprising DL between the UE and a neighbor node and UL between the UE and the serving node of the UE.

According to some embodiments, a method is provided to determine position of a user equipment (UE) in the UE. The method includes obtaining assistance data from a network node for determining the position of the UE at the UE. The method further includes performing a round trip time, RTT measurement procedure with a serving cell base station to obtain a RTT measurement. The method further includes measuring a received time of a downlink position reference signal, DL PRS, from one or more neighbor base stations based on the assistance data obtained. The method further includes estimating the position using the assistance data, the RTT measurement and the received time of the DL PRS.

According to some other embodiments, a UE is provided that performs analogous operations.

One advantage that may be provided is using only one uplink and DL connected to the serving cell for measurements to determine the position of the wireless device UE. This advantage provides a more reliable link compared to neighbor cells having to listen to the uplink SRS. Significantly less signaling overhead may be used compared to symmetric RxTx (where the UE transmits in UL to neighbor cells). A further advantage that may be provided for UE-based positioning is enabling the use of common information that is the same for multiple UEs, which reduces complexity and signaling load. This advantage provides an efficient way of supporting wireless device UE-based multicell RTT in a network with multiple base stations.

According to other embodiments, a method of providing assistance data in a network node for a UE to determine position of the UE is provided. The method includes obtaining information indicative of a distance to each of one or more neighbor base stations of a serving cell base station of the wireless device UE. The method further includes obtaining location information of the serving cell base station and the one or more neighbor base stations. The method further includes providing assistance data to the UE, the assistance data comprising the information indicative of the distance to each of the one or more neighbor base stations and the location information of the serving cell base station and the one or more neighbor base stations.

According to some other embodiments, a network node is provided that performs analogous operations.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating NG-RAN Rel-15 LCS Protocols;

FIG. 2 is a block diagram illustrating a deployment scenario of a UE;

FIG. 3 is a block diagram illustrating an RTT principle for a UE according to some embodiments of inventive concepts;

FIG. 4 is a block diagram illustrating a multi-cell RTT according to some embodiments;

FIG. 5 is a block diagram illustrating signaling flows and transmission and reception times according to some embodiments of inventive concepts when the UL PRS is sent with a time offset after a downlink reference time defined by the reception time of a DL PRS;

FIG. 6 is a block diagram illustrating signaling flows and transmission and reception times according to some embodiments of inventive concepts when the UL PRS is sent with a time offset after a downlink reference time defined by the predicted reception time of a periodic DL PRS of periodicity P;

FIG. 7 is a flow diagram illustrating signaling between the UE and network nodes according to some embodiments of inventive concepts;

FIG. 8 is a block diagram illustrating a user equipment according (e.g., UE, a mobile terminal, etc.) according to some embodiments of inventive concepts;

FIG. 9 is a block diagram illustrating a radio access network RAN node (e.g., a base station eNB/gNB) according to some embodiments of inventive concepts;

FIGS. 10-11 are flowcharts illustrating operations of a wireless device user equipment according to some embodiments of inventive concepts;

FIG. 12 is a flow chart illustrating operations of network nodes according to some embodiments of inventive concepts;

FIG. 13 is a block diagram of a wireless network in accordance with some embodiments;

FIG. 14 is a block diagram of a user equipment in accordance with some embodiments;

FIG. 15 is a block diagram of a virtualization environment in accordance with some embodiments;

FIG. 16 is a block diagram of a telecommunication network connected via an intermediate network to a host computer in accordance with some embodiments;

FIG. 17 is a block diagram of a host computer communicating via a base station with a user equipment over a partially wireless connection in accordance with some embodiments;

FIG. 18 is a block diagram of methods implemented in a communication system including a host computer, a base station and a user equipment in accordance with some embodiments;

FIG. 19 is a block diagram of methods implemented in a communication system including a host computer, a base station and a user equipment in accordance with some embodiments;

FIG. 20 is a block diagram of methods implemented in a communication system including a host computer, a base station and a user equipment in accordance with some embodiments; and

FIG. 21 is a block diagram of methods implemented in a communication system including a host computer, a base station and a user equipment in accordance with some embodiments.

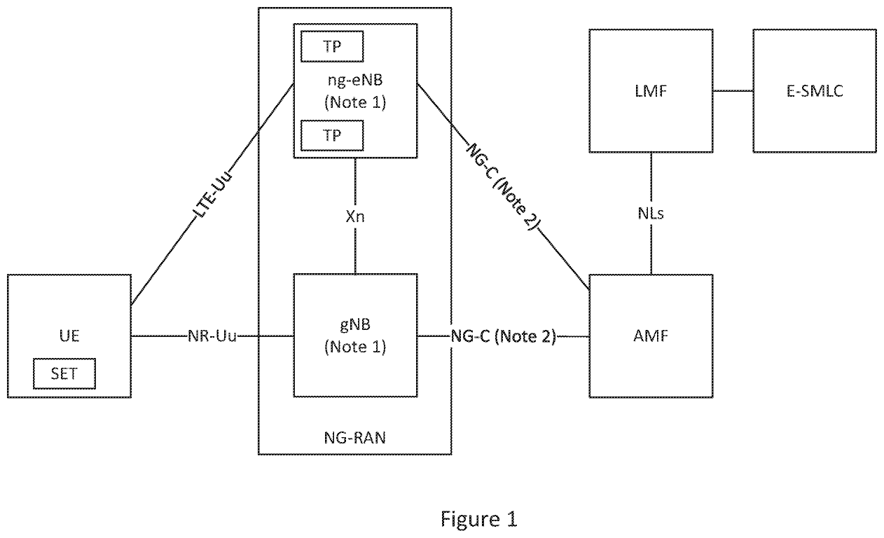

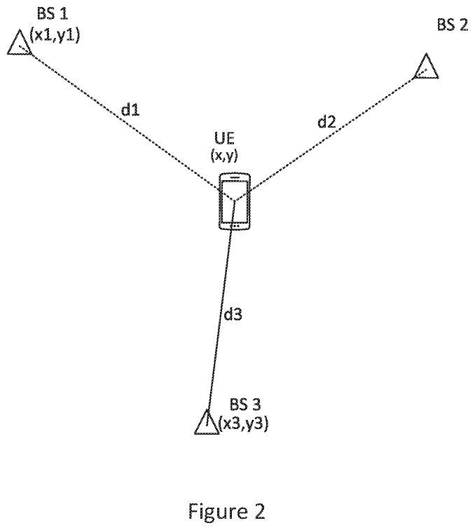

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

In the description herein, downlink position reference signal (DL PRS) may be any DL reference signal or channel used for positioning RTT measurements, SSB, synchronization signal, positioning reference signal, CSI-RS, TRS, etc. uplink PRS (UL PRS) may be any UL reference signal or channel used for positioning RTT measurements, SRS, PRACH, etc. RTT measurements may be a timing measurement reflecting the range or distance between UE and at least one network node, Rx-Tx, Rx-Tx difference (difference between two Rx-Tx measurements or estimates, e.g., with respect to different cells or nodes), RTT, RTT difference (difference between two RTT measurements or estimates, e.g., with respect to different cells or nodes), etc. can be UE RTT measurements (e.g., the time between reception at the UE and transmission from the UE) or base station RTT measurements (e.g., the time between reception at the base station and transmission from the base station) or a combination of the two (e.g., a function such as a sun of UE Rx-Tx and base station Rx-Tx). RTT measurement can be symmetric (DL and UL between the UE and the same base station or network node) or asymmetric (e.g., DL and UL between the UE and different base stations or network nodes such as DL is between UE and neighbor cell and UL is between UE and serving cell). The Tx time does not necessarily comprise only the time of the actual transmission but may also comprise the time of an UL time resource (e.g., UL slot or UL, subframe) associated with the time of a signal received in DL (e.g., from a neighbor cell).

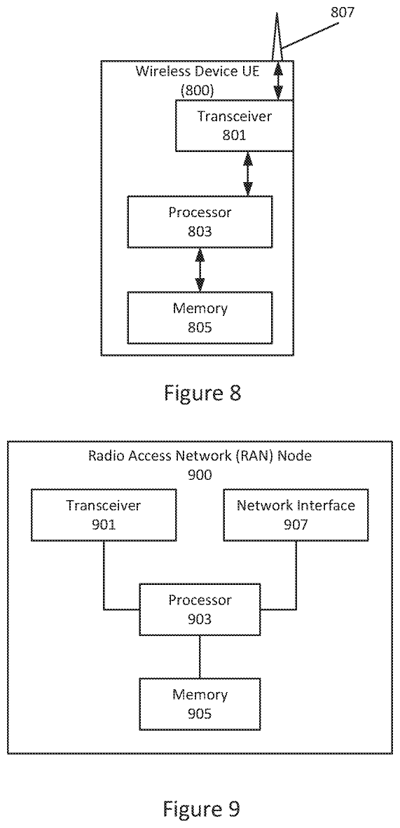

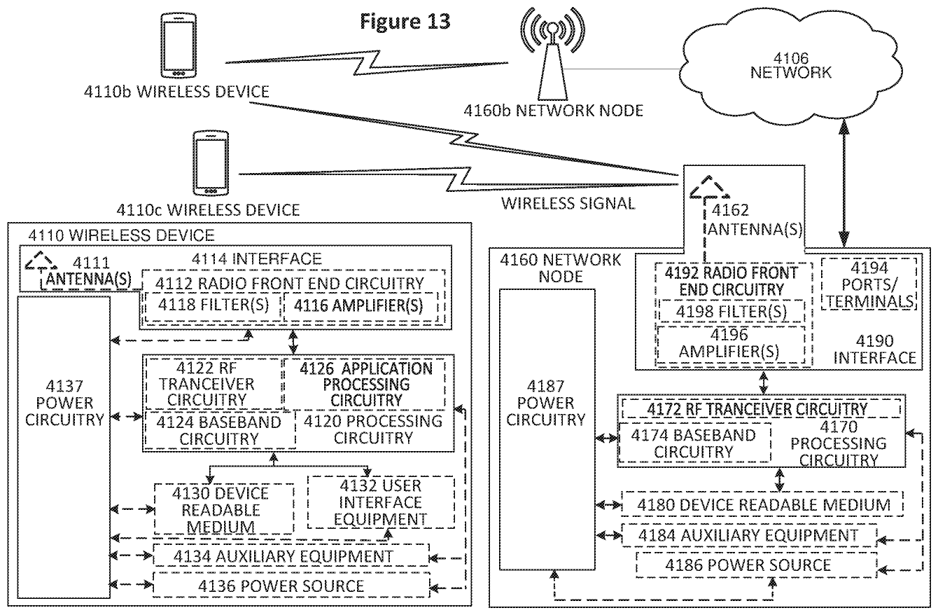

FIG. 8 is a block diagram illustrating elements of a wireless device UE 800 (also referred to as a mobile terminal, a mobile communication terminal, a wireless communication device, a wireless terminal, a wireless communication terminal, user equipment, UE, a user equipment node/terminal/device, etc.) configured to provide wireless communication according to embodiments of inventive concepts. (Wireless device UE 800 may be provided, for example, as discussed below with respect to wireless device 4110 of FIG. 13.) As shown, wireless device UE may include an antenna 807 (e.g., corresponding to antenna 4111 of FIG. 13), and transceiver circuitry 801 (also referred to as a transceiver, e.g., corresponding to interface 4114 of FIG. 13) including a transmitter and a receiver configured to provide uplink and downlink radio communications with a base station(s) (e.g., corresponding to network node 4160 of FIG. 13) of a radio access network. Wireless device UE 800 may also include processing circuitry 803 (also referred to as a processor, e.g., corresponding to processing circuitry 4120 of FIG. 13) coupled to the transceiver circuitry, and memory circuitry 805 (also referred to as memory, e.g., corresponding to device readable medium 4130 of FIG. 13) coupled to the processing circuitry. The memory circuitry 805 may include computer readable program code that when executed by the processing circuitry 803 causes the processing circuitry to perform operations according to embodiments disclosed herein. According to other embodiments, processing circuitry 803 may be defined to include memory so that separate memory circuitry is not required. Wireless device UE may also include an interface (such as a user interface) coupled with processing circuitry 903, and/or wireless device UE may be incorporated in a vehicle.

As discussed herein, operations of wireless device UE 800 may be performed by processing circuitry 803 and/or transceiver circuitry 801. For example, processing circuitry 803 may control transceiver circuitry 801 to transmit communications through transceiver circuitry 801 over a radio interface to a radio access network node (also referred to as a base station) and/or to receive communications through transceiver circuitry 801 from a RAN node over a radio interface. Moreover, modules may be stored in memory circuitry 805, and these modules may provide instructions so that when instructions of a module are executed by processing circuitry 803, processing circuitry 803 performs respective operations (e.g., operations discussed below with respect to Example Embodiments relating to wireless devices).

FIG. 9 is a block diagram illustrating elements of a radio access network RAN node 900 (also referred to as a network node, base station, eNodeB/eNB, gNodeB/gNB, etc.) of a Radio Access Network (RAN) configured to provide cellular communication according to embodiments of inventive concepts. (RAN node 900 may be provided, for example, as discussed below with respect to network node 4160 of FIG. 13.) As shown, the RAN node may include transceiver circuitry 901 (also referred to as a transceiver, e.g., corresponding to portions of interface 4190 of FIG. 13) including a transmitter and a receiver configured to provide uplink and downlink radio communications with mobile terminals. The RAN node may include network interface circuitry 907 (also referred to as a network interface, e.g., corresponding to portions of interface 4190 of FIG. 13) configured to provide communications with other nodes (e.g., with other base stations) of the RAN and/or core network CN. The network node may also include a processing circuitry 903 (also referred to as a processor, e.g., corresponding to processing circuitry 4170) coupled to the transceiver circuitry, and a memory circuitry 905 (also referred to as memory, e.g., corresponding to device readable medium 4180 of FIG. 13) coupled to the processing circuitry. The memory circuitry 905 may include computer readable program code that when executed by the processing circuitry 903 causes the processing circuitry to perform operations according to embodiments disclosed herein. According to other embodiments, processing circuitry 903 may be defined to include memory so that a separate memory circuitry is not required.

As discussed herein, operations of the RAN node may be performed by processing circuitry 903, network interface circuitry 907, and/or transceiver circuitry 901. For example, processing circuitry 903 may control transceiver circuitry 901 to transmit downlink communications through transceiver circuitry 901 over a radio interface to one or more mobile terminals UEs and/or to receive uplink communications through transceiver circuitry 901 from one or more mobile terminals UEs over a radio interface. Similarly, processing circuitry 903 may control network interface circuitry 907 to transmit communications through network interface circuitry 907 to one or more other network nodes and/or to receive communications through network interface from one or more other network nodes. Moreover, modules may be stored in memory 1005, and these modules may provide instructions so that when instructions of a module are executed by processing circuitry 903, processing circuitry 903 performs respective operations (e.g., operations discussed below with respect to Example Embodiments relating to RAN nodes).

According to some other embodiments, a network node may be implemented as a core network CN node without a transceiver. In such embodiments, transmission to a wireless device UE may be initiated by the network node so that transmission to the wireless device is provided through a network node including a transceiver (e.g., through a base station or RAN node). According to embodiments where the network node is a RAN node including a transceiver, initiating transmission may include transmitting through the transceiver.

In UE-based positioning, the network provides assistance data and measurements to the wireless device UE to enable positioning in the wireless device UE. Potentially, this can imply significant signaling to the plethora of wireless device UEs in the network, which can cause delays and lead to signaling load issues. Also, schemes that involve UE-specific network inter-node signaling and UL reception at multiple network nodes will cause extensive signaling in the network.

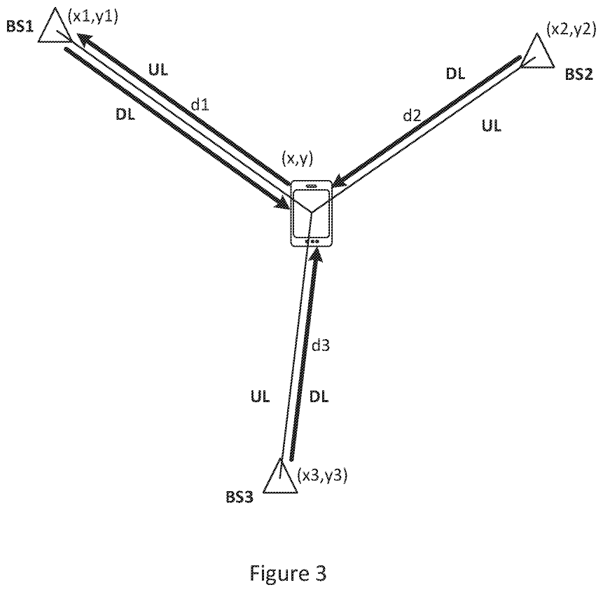

In terms of position measurements from the wireless device UE 800 perspective, the wireless device UE 800 may receive a request to provide capabilities of the wireless device UE with respect to position measurements and calculations. The request may come from network node 900. The position measurements may be round trip time (RTT) measurements such as any time-based bidirectional measurement, e.g., Rx-Tx, RTT, etc., comprising DL and UL component. In some embodiments, the wireless device UE may provide the device's capability of what type of RTT measurement the wireless device UE may support. For example, in one embodiment, the wireless device UE 800, e.g., indicating the support of RTT for one or more of the below:
Serving cell only RTT (for example, UL and DL between the wireless device UE and BS1 in FIG. 3)
Asymmetric RTT, e.g., comprising DL from neighbor cells and UL for the serving cell (for example, UL between the wireless device UE and BS1 and DL from BS2 and BS3 in FIG. 3)
Symmetric RTT, comprising DL and UL for the same link
Difference between asymmetric neighbor cell RTT and reference RTT (e.g., serving cell RTT)
Difference between symmetric neighbor cell RTT and reference RTT (e.g., serving cell RTT)

The wireless device UE 800 may request positioning assistance data from UE-based positioning. The wireless device UE 800 obtains assistance data for UE-based positioning from a network node comprising at least the information indicative of the range to neighbor cells, which may comprise any one or more of:
Time of arrival of neighbor cell signal at the serving cell;
Time difference of arrival of neighbor cells at the serving cell or an offset relative to a reference time (e.g., serving cell reference time);
Estimated time of arrival of neighbor cell signal at the wireless device UE;
Time difference of arrival of neighbor cells at the serving cell or an offset relative to a reference time (e.g., serving cell time of arrival or subframe/slot/radio frame with a certain index), to be used for E-CID positioning or wireless device UE Rx-Tx measurements or wireless device UE RTT measurements;
Estimated time T0 of arrival of the serving cell signal and a search window (e.g., centered at T0) within which the neighbor cell signals are expected to arrive at the wireless device UE, to be used for E-CID positioning or wireless device UE Rx-Tx measurements or wireless device UE RTT measurements; and/or
information about the location of the base station antennas (for one or more of the serving base station and neighbor base stations).

The wireless device UE 800 may perform one or more wireless device UE RTT measurements with the serving node and may use them for positioning. In other embodiments, the wireless device UE 800 may report them or a function of them (e.g., the difference between neighbor RTT and serving RTT) to a network node (e.g., serving cell or location server). In one embodiment, the wireless device UE device may report the measurement together with the corresponding beam ID or SSB ID. In another example, the wireless device UE device may provide the result in an ordered list that was configured by the network, thereby avoiding the need to provide explicit cell id, which may save signaling bits in UL.

The wireless device UE 800 may measure received time of downlink signals from one or more neighbor base station, based on the obtained assistance data. The wireless device UE 800 may estimate the wireless device UE's position using the obtained information and measurements. The wireless device UE 800 may send the estimated position to another wireless device UE or to a network node, e.g., upon a request or in an unsolicited way.

In terms of position measurements from the network perspective, the network node 900 (e.g., base station, core network node, location server, etc.) may transmit to the wireless device UE 800 a request to provide capabilities of the wireless device UE 800 related to position measurements and calculations. The network node 900 obtains the capability of the wireless device UE 800. For example, in one embodiment, the network node 900 may obtain what type of RTT measurement is supported by the wireless device UE 800, e.g., indicating the support of RTT for one or more of the below:
Serving cell only RTT
Asymmetric RTT, e.g., comprising DL from neighbor cells and UL for the serving cell
Symmetric RTT, comprising DL and UL for the same link
Difference between asymmetric neighbor cell RTT and reference RTT (e.g., serving cell RTT)
Difference between symmetric neighbor cell RTT and reference RTT (e.g., serving cell RTT)

The network node 900 may obtain from a wireless device UE 800 a positioning assistance data request. The network node 900 may obtain information indicative of the range to the neighbor cells, which may comprise any one or more of:
Time of arrival of neighbor cell signal at the serving cell,
Time difference of arrival of neighbor cells at the serving cell or an offset relative to a reference time (e.g., serving cell reference time),
Estimated time of arrival of neighbor cell signal at the wireless device UE,
Time difference of arrival of neighbor cells at the serving cell or an offset relative to a reference time (e.g., serving cell time of arrival or subframe/slot/radio frame with a certain index), to be used for E-CID positioning or wireless device UE Rx-Tx measurements or wireless device UE RTT measurements,
Estimated time T0 of arrival of the serving cell signal and a search window (e.g., centered at T0) within which the neighbor cell signals are expected to arrive at the wireless device UE, to be used for E-CID positioning or wireless device UE Rx-Tx measurements or wireless device UE RTT measurements, and/or
information about the location of the base station antennas (for one or more of the serving base station and neighbor base stations).

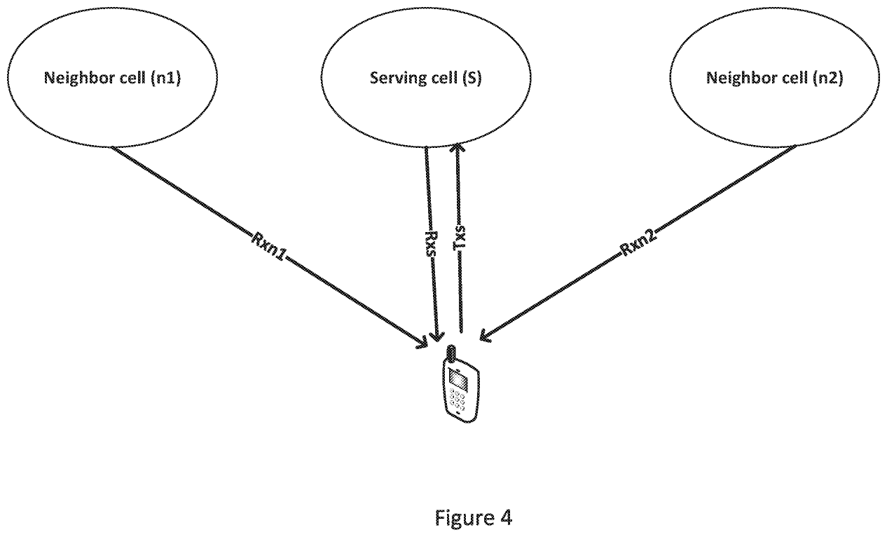

Turning to FIG. 4, a multi-cell RTT scenario is illustrated. In FIG. 4, Rxn1, Rxn2 are the received neighbor cell time computed by wireless device UE, Rxs is the serving cell received signal time and Txs is the time when the wireless device UE transmits in UL to the wireless device UE's serving cell.

The wireless device UE Rx-Tx measurements may be bidirectional measurements involving both DL and UL. Multi-cell RTT based on wireless device UE Rx-Tx measurements could be based on measuring DL signals from the serving and neighbor cells but with the UL transmission either to the serving cell only (option 1) or also to neighbor cells (option 2).

Option 1 (DL from serving and neighbor cells and UL transmission to the serving cell only) may be less complex for both the wireless device UE and the network, less power consuming, and requires less signaling), while option 2 may be much more complex with unclear additional benefits. FIG. 4 depicts Option 1.

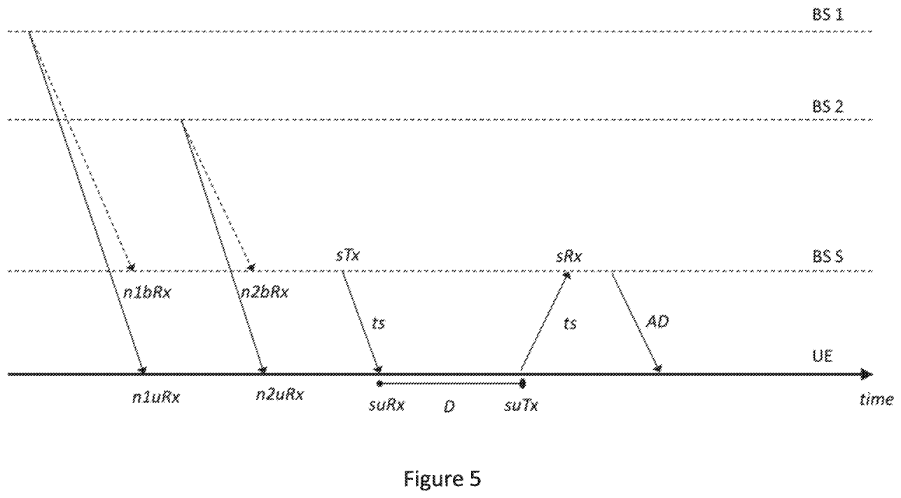

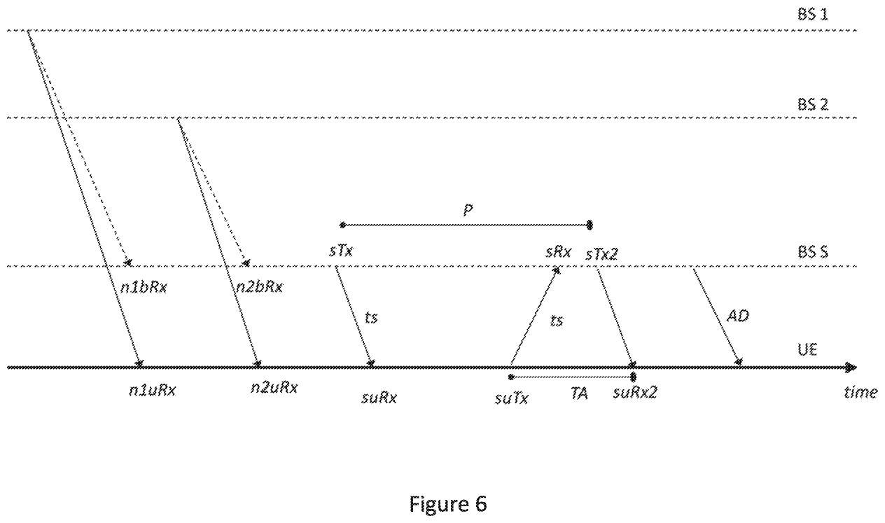

The positioning procedure may depend on whether it is based on UL PRS sent with a transmission time defined as a positive offset D in relation to a previous reference time defined by the reception time of a DL PRS (see FIG. 5) or based on UL PRS sent with a transmission time defined as a timing advance TA in relation to a predicted future reference time defined by a periodic DL PRS (see FIG. 6).

In some embodiments the same wireless device UE may determine an offset with respect to a reference time to be always positive. In other embodiments, the offset may be negative. Yet, in other embodiments it may be negative for some cells and positive for other cells (e.g., it can be positive [i.e., Rx is later than Tx] at least for the serving cell and it may be negative for at least some neighbor cells, especially if the Tx time is always the time of the transmission to the wireless device UE's serving cell).

Turning to FIG. 5, signaling flows, transmission, and reception times are illustrated when the UL PRS is sent with a time offset after a downlink reference time defined by the reception time of a DL PRS. The RTT can also be based on Rx-Tx. Note that transmission is not always after the reception in the Rx-Tx. For example, in a synch network, the wireless device UE Tx is before the Rx.

The wireless device UE 800 may combine three kinds of information that can be described in four categories, with references to the reception and transmission times in FIG. 6. These four categories are:
Base station antenna positions, serving and neighbor base stations
Serving cell round-trip-time, e.g. calculated as follows (but not limited to):

dₛ={square root over ((x−xₛ)²+(y−yₛ²)}
The wireless device UE is configured to transmit an uplink signal at a time suTx related to a downlink device time reference. In one example, the downlink device time reference is the downlink PRS reception time suRx, and the transmission time is the time D after the reference time. This means suTx=suRx+D.
The serving base station (e.g., network node 900) provides information to the wireless device UE concerning the time difference between the reception time of the uplink signal and a downlink serving cell time reference. In one example, the downlink serving cell time reference is the downlink PRS transmission time. This means that the base station provides sRx and sTx, or in one embodiment, the relative difference (sRx−sTx).
The round trip time (2 times the time of flight ts) can be estimated as

2 ts=(sRX−sTX)−(suTx−suRx)
Furthermore, the relative distance ds between serving cell and the wireless device UE is ds=ts*c, where c is the speed of light.
Device measurements of neighbor downlink PRS
   Generates n1uRx, n2uRx etc
Serving cell relative timing information about serving cell received time of a neighbor cell signal and a serving cell reference time. One example of a serving cell reference time is the downlink PRS transmission time.
   Provides n1bRx, n2bRx, optionally relative to a reference time such as a serving cell downlink transmission time.

Based on the provided information, the wireless device UE 800 is able to estimate its position.

Turning to FIG. 6, signaling flows, transmission and reception times is illustrated when the UL PRS is sent with a time offset (timing advance) before a downlink reference time defined by the predicted reception time of a periodic DL PRS of periodicity P.

The wireless device UE 800 may combine three kinds of information that can be described in four categories, with references to the reception and transmission times in FIG. 6. These four categories are:
Base station antenna positions, serving and neighbor base stations
Serving cell round-trip-time, e.g. calculated as follows (but not limited to):

dₛ=\sqrt{(x−xₛ)²+(y−yₛ)²}
The wireless device UE is configured to transmit an uplink signal at a time suTx related to a downlink device time reference. In one example, the downlink device time reference is the predicted downlink PRS reception time suRx2, and the transmission time is TA ahead of the reference time. This means suTx=suRx2−TA.
The serving base station (e.g., network node 900) provides information to the wireless device UE concerning the time difference between the reception time of the uplink signal and a downlink serving cell time reference. In one example, the downlink serving cell time reference is the downlink PRS transmission time. This means that the base station provides sRx and sTx2 (or sTx where the periodicity is known from the DL PRS configuration), or in one embodiment, the relative difference (sTx2−sRx) or (sRx−sTx).
The round trip time (2 times the time of flight ts) can be estimated as
   2 ts=(suTx−suRx2)−(sTx2−sRx) or
   2 is =(suTx−suRx2)−(P−(sRx−sTx)) depending on whether the base station provides information about sTx or sTx2
Furthermore, the relative distance ds between the serving cell and the wireless device UE is ds=ts*c, where c is the speed of light.
Device measurements of neighbor downlink PRS
   Generates n1uRx, n2uRx etc
Serving cell relative timing information about serving cell received time of a neighbor cell signal and a serving cell reference time. One example of a serving cell reference time is the downlink PRS transmission time.
   Provides n1bRx, n2bRx,
   Optionally these measurements may be provided relative to a reference time such as a serving cell downlink transmission time to provide (n1bRx−sTx), (n2bRx−sTx).

Based on the provided information, the wireless device UE 800 is able to estimate its position.

In an example derivation of position of the wireless device UE 800, the distance between the wireless device US 800 and a neighbor base station can be determined as below. The derivation notation is for neighbor 1, which may be extended to any base station. The derivation is as follows:
Determine the distance ds1 between serving BS and neighbor BS 1
Denote the neighbor DL PRS transmission time b1Tx (not used explicitly)
Determine the distance d1 between the device and neighbor BS 1:
d1=d1−ds1+ds1=(n1uRx−n1Tx)−(n1bRx−n1Tx)+ds1=(n1uRx−n1bRx)+ds1
This will include the clock offset A between the serving base station and the wireless device UE, due to the relative difference of the time observations at the serving BS and the wireless device UE. Therefore, this parameter also needs to be estimated
An alternative is to use relative time measurements in relation to a serving cell and the wireless device UE time reference respectively. In this case, the clock offset between serving cell and wireless device UE is present and needs to be estimated.
d1=d1−ds1+ds1=(n1uRx−n1Tx)−(n1bRx−n1Tx)+ds1=(n1uRx−n1bRx)+ds1=(n1uRx−suRx+suRx−n1bRx−sTx+sTx)+ds1==ds1−(suRx−n1uRx)+(suRx−sTx)+(sTx−n1bRx)==ds1−(suRx−n1uRx)+ds+(sTx−n1bRx)
Similarly, d2=ds2−(suRx−n2uRx)+ds+(sTx−n2bRx) for a second neighbor base station where the distance ds2 is the distance between the serving BS and neighbor BS 2

Given estimated distances to the serving BS and one or more neighbor BS the wireless device UE can estimate the wireless device UE position.

The wireless device UE is configured with assistance data (AD) to enable the positioning. The AD comprises positions of the serving and a set of neighbor base stations, a set of received signal measurements from neighbor DL PRS observed by the serving cell, and a set of neighbor DL PRS for the wireless device UE to measure on. In addition, the wireless device UE may be configured with a serving cell RTT procedure to use.

Positions of the Serving and a Set of Neighbor Base Stations

The wireless device UE 800 may be provided with the base station coordinates associated to a coordinate system. The coordinate system may be earth centered, earth bound (ECEB). The coordinates may be defined according to the WGS 84 reference system. Other coordinate systems and reference systems can also be used. In one mode of the embodiments, the coordinate system and/or the reference system information is provided with the configuration.

DL PRS Received Signal TOA Measurements by Serving Cell

The serving cell may measure TOA from neighbor BS DL PRS, and corresponding information may be included in the configuration to the wireless device UE 800. In one embodiment, the wireless device UE 800 may be provided with the TOA measurements themselves. In a preferred embodiment, the wireless device UE 800 may instead be provided with the neighbor DL PRS TOA relative to a serving cell reference time. In one mode of the embodiment, the reference time is the most recent transmission time of serving cell DL PRS. In another mode, it is the transmission of some other serving cell reference signal.

DL PRS Configurations

A set of DL PRS associated to serving and neighbor cells is provided to the wireless device UE 800. The definition of the DL PRS may be separated into a definition of a signal data sequence, a signal symbol pattern, a resource definition and a resource set definition (multiple beams). The DL PRS is associated to an Id.

Wireless Device UE 800 Serving Cell RTT Procedure

The serving cell RTT procedure is typically configured by the serving cell, but the triggering can be by the network node, either to the serving base station or to the wireless device UE 800. The triggering is typically initiated by the request for assistance data by the wireless device UE 800.

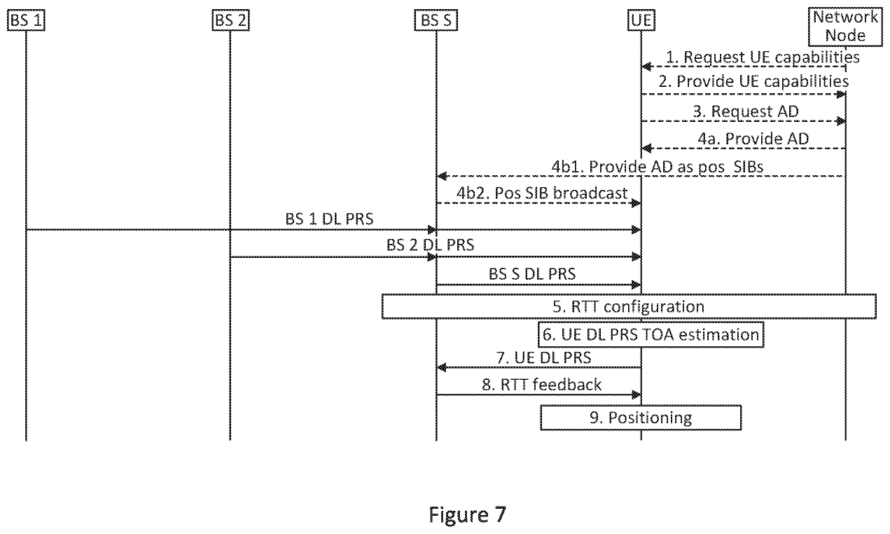

The serving cell RTT procedure for wireless device UE-based positioning comprises the configuration of an uplink signal and an uplink resource, as well as an uplink timing configuration in relation to a downlink reference time. In one preferred mode, the reference time is the reception time of a DL PRS, and the relation is a configured offset, either as a positive offset to define a transmission time after a reception time of DL PRS (this is illustrated by AD in FIG. 7), or a positive offset to define a transmission time before a predicted reception time of a periodic DL PRS, typically based on the reception time of the previously transmitted DL PRS plus the periodicity of DL PRS.

As part of the RTT procedure, the wireless device UE 800 obtains information from the serving base station about the time relation of a transmission time of a DL PRS and a reception time of an UL PRS.

In FIG. 7 the DL PRS transmission time is denoted sTx and the UL PRS reception time is denoted sRx in reference to the serving cell. In one mode, the information is encoded as the time difference between sRx and sTx.

Signaling

In one signaling embodiment, the assistance data to the wireless device UE 800 is transmitted by a location server. In another embodiment, the assistance data to the wireless device UE 800 is transmitted by a network node, e.g., serving cell.

The assistance data can be comprised in UE-dedicated signaling or multicast (can be received by some wireless device UE) or broadcast (can be received by all wireless device UE) messages.

One signaling example is illustrated in FIG. 7, which is an illustration of a signaling chart. The operations illustrated in FIG. 7 may be described as follows:

Operations 1, 2. Optionally upon request from a network node, the wireless device UE 800 will optionally provide its capabilities associated to positioning.

Operation 3. The wireless device UE 800 may request AD to support device-based RTT-based positioning

Operation 4. The wireless device UE 800 may be provisioned with assistance data to support device-based RTT-based positioning, where the provisioning can be provided directly from a network node to a specific device (4a) or via broadcast from a base station to a multitude of devices (4b). The AD may comprise TOA measurements by the serving cell based on DL PRS from neighbor cells

Operation 4a. The network node provides AD to the wireless device UE 800

Operation 4b1. The network node compiles AD and sends to a base station for broadcast

Operation 4b2. The base station broadcasts AD to the wireless device UEs 800

Operation 5. The wireless device UE 800 is configured for a serving cell RTT procedure

Operation 6. The wireless device UE 800 monitors DL PRS transmissions from serving and neighbor base stations and estimate DL TOA per base station/cell.

Operation 7. The wireless device UE 800 also transmits an UL PRS configured as part of the RTT configuration.

Operation 8. The serving cell provides RTT feedback to the wireless device UE 800, optionally

Operation 9. The wireless device UE 800 estimates the wireless device UE position or updates the wireless device UE position estimate

An example ASN.1 by creating new message and by extending E-CID existing signaling is provided below.

```
-- ASN1START
E-CID-ProvideAssistanceData-r16 ::= SEQUENCE {
  multicellRTT-AssistaceDataList MultiCellRTT-AssistanceDataList-r16 OPTIONAL,
    -- Need ON
  ...
}
-- ASN1STOP
```

Further, in an embodiment, the network configures the type of Multi-cell RTT that UE and base stations should perform. Depending upon the network and UE capability, the network may configure one of the RTT; a simplified-RTT, combined UL and DL (ulplusdl-RTT) or the overhearing-RTT.

MultiCellRTT-AssistanceDataList-r16 ::= SEQUENCE {

| multicell-RTT-type-r16 | ENUMERATED {simplified-rtt, ulplusdl-rtt, overhearing}, | | |
|---|---|---|---|
| servingCellInfo-r16 | ServingCellInfo-r16 | OPTIONAL, | -- Need ON |
| neighbourCellInfo-r16 | NeighbourCellInfoList-r16 | OPTIONAL | -- Need ON |

```
  ...
  }
```

Further, a simplified, multi-cell RTT contains the following configuration parameters:
Serving cell: CELL ID, DL PRS, antenna position
Neighbor cell: DL PRS, antenna position, serving cell DL PRS reception time information

In systems where multiple beams are configured, there can be multiple serving cell and/or neighbor cell beams configured and associated to DL PRS.

NeighbourCellInfoList-r16 ::= SEQUENCE (SIZE (1..maxNC)) OF NeighbourCellInfoElement
NeighbourCellInfoElement ::= SEQUENCE {

| physCellId | INTEGER (0..1005), | | |
|---|---|---|---|
| cellGlobalId | ECGI | OPTIONAL, | -- Need ON |
| dl-PrsInfo | Dl-PRS-Info | OPTIONAL, | -- Cond PRS |
| servingCellDlPrsMeas | ServingCellDlPrsMeas | OPTIONAL | |

...
}
ServingCellInfo-r16 ::= SEQUENCE {

| physCellId | INTEGER (0..1005), | | |
|---|---|---|---|
| cellGlobalId | ECGI | OPTIONAL, | -- Need ON |
| dl-PrsInfo | Dl-PRS-Info | OPTIONAL, | -- Cond PRS |

...
}

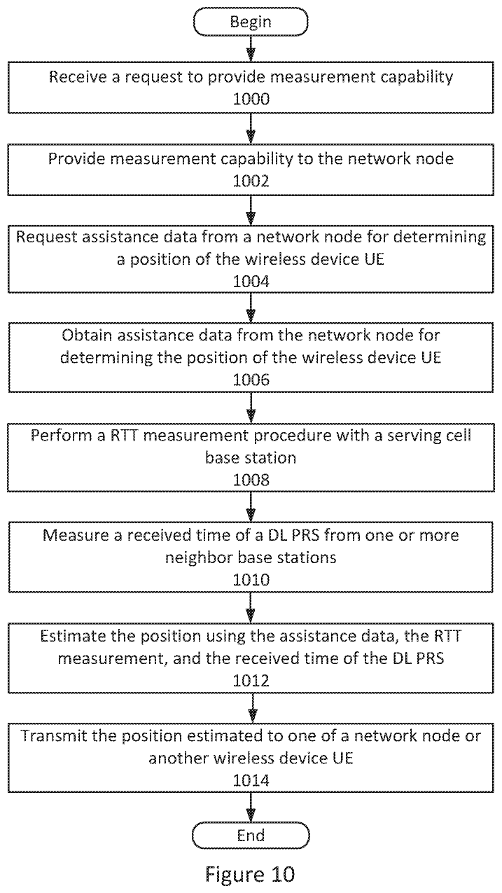

Operations of the wireless device UE 800 (implemented using the structure of the block diagram of FIG. 8) will now be discussed with reference to the flow chart of FIG. 10 according to some embodiments of inventive concepts. For example, modules may be stored in memory 805 of FIG. 8, and these modules may provide instructions so that when the instructions of a module are executed by respective wireless device processing circuitry 803, processing circuitry 803 performs respective operations of the flow chart.

Turning to FIG. 10, in operation 1000, processing circuitry 803 may, via transceiver circuitry 801, receive a request to provide measurement capability of the wireless device UE 800. The requestor may be a base station, a location server node, a network node, a core network node, etc. In operation 1002, the processing circuitry 803 may provide, via transceiver circuitry 801, measurement capability of the wireless device UE to the requestor of the measurement capability. For example, the processing circuitry 803 may provide an indication that the wireless device UE 800 may support a Serving cell only RTT, Asymmetric RTT, e.g., comprising DL from neighbor cells and UL for the serving cell, symmetric RTT, comprising DL and UL for the same link, a difference between asymmetric neighbor cell RTT and reference RTT (e.g., serving cell RTT), and/or a difference between symmetric neighbor cell RTT and reference RTT (e.g., serving cell RTT).

In operation 1004, the processing circuitry 803, may via transceiver circuitry 801, request assistance data from a network node for determining a position of the wireless device UE 800. In operation 1006, the processing circuitry 803, may via transceiver circuitry 801, obtain assistance data from the network node for determining the position of the wireless device UE 800. The assistance data may include information indicative of the range to neighbor cells, which may comprise any one or more of:
Time of arrival of neighbor cell signal at the serving cell;
Time difference of arrival of neighbor cells at the serving cell or an offset relative to a reference time (e.g., serving cell reference time);
Estimated time of arrival of neighbor cell signal at the wireless device UE;
Time difference of arrival of neighbor cells at the serving cell or an offset relative to a reference time (e.g., serving cell time of arrival or subframe/slot/radio frame with a certain index), to be used for E-CID positioning or wireless device UE Rx-Tx measurements or wireless device UE RTT measurements;
Estimated time T0 of arrival of the serving cell signal and a search window (e.g., centered at T0) within which the neighbor cell signals are expected to arrive at the wireless device UE, to be used for E-CID positioning or wireless device UE Rx-Tx measurements or wireless device UE RTT measurements; and/or
information about the location of the base station antennas (for one or more of the serving base station and neighbor base stations).

In operation 1008, the processing circuitry 803 may perform an RTT measurement procedure with the serving cell base station. In operation 1010, the processing circuitry 803 may measure a received time of a DL PRS from one or more neighbor base stations. The measurement may be based on the assistance data obtained. For example, the wireless device UE may perform the measurements illustrated in FIG. 5 or FIG. 6 depending on when the UL PRS is sent.

In operation 1012, the processing circuitry 803 may estimate the position of the wireless device UE using the assistance data, the RTT measurement procedure, and the received time of the DL PRS.

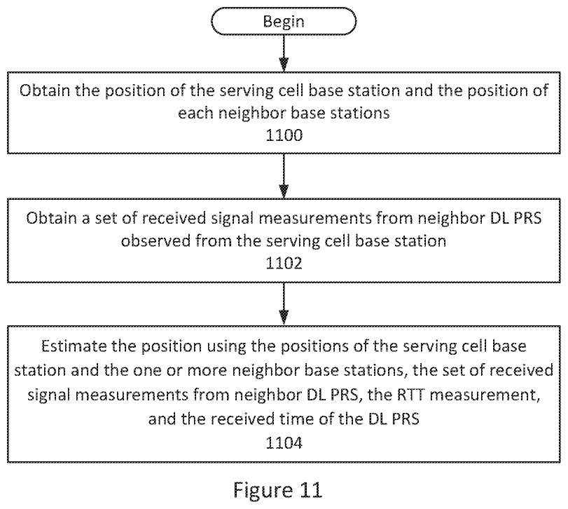

For example, turning to FIG. 11, the processing circuitry 803 in operation 1100 may obtain the position of the serving cell base station and the position of each of the neighbor base stations. In operation 1102, the processing circuitry 803 may obtain a set of received signal measurements from neighbor DL PRS observed from the serving cell base station. This information may be obtained from the assistance data.

In operation 1104, the processing circuitry 803 may estimate the position using the position of the serving cell base station, the position of the one or more neighbor base stations, the set of received signal measurements from neighbor DL PRS observed from the serving cell base station, the RTT measurement procedure with the serving cell base station, and the received time of the DL PRS from the one or more neighbor base stations.

In one embodiment, estimating the position may be based on the signaling flow illustrated in FIG. 5:

ds=ts*c=½ RTT*c=½(sRX−sTX)−(suTx−suRx);

dn1=ds1−(suRX−n1uRx)+ds+(sTx−n1bRx); and

dn2=ds2−(suRx−n2uRx)+ds+(sTx−n2bRx),

where c is a speed of light, ts is a time of flight, sRX is a reception time of an uplink signal from the wireless device UE, sTX is a time a downlink PRS signal is transmitted to the wireless device UE, suTX is a time the uplink signal is transmitted from the wireless device UE, suRX is a downlink PRS reception time at the wireless device UE, ds is a distance between the serving cell base station and the wireless device UE, ds1 is a distance between the serving cell base station and a first one of the one or more neighbor base stations, ds2 is a distance between the serving cell base station and a second one of the one or more neighbor base stations, dn1 is a distance between the wireless device UE and the first one of the one or more neighbor base stations, and dn2 is a distance between the wireless device UE and the second one of the one or more neighbor base stations.

In another embodiment, estimating the position may be based on the signaling flow illustrated in FIG. 6:

ds=ts*c=½RTT*c=c/2((suTX−suRX2)−(sTx2−sRx))=c/2((suTX−suRX2)−(P−(sRx−sTx));

dn1=ds1−(suRX−n1uRx)+ds+(sTx−n1bRx); and

dn2=ds2−(suRx−n2uRx)+ds+(sTx−n2bRx),

where c is a speed of light, ts is a time of flight, sRX is a reception time of an uplink signal from the wireless device UE, sTX is a time a downlink PRS signal is transmitted to the wireless device UE, suTX is a time the uplink signal is transmitted from the wireless device UE, suRX2 is a downlink PRS reception time at the wireless device UE, P is a periodicity of a periodic DL PRS, ds is a distance between the serving cell base station and the wireless device UE, ds1 is a distance between the serving cell base station and a first one of the one or more neighbor base stations, ds2 is a distance between the serving cell base station and a second one of the one or more neighbor base stations, dn1 is a distance between the wireless device UE and the first one of the one or more neighbor base stations, and dn2 is a distance between the wireless device UE and the second one of the one or more neighbor base stations.

Returning to FIG. 10, in operation 1014, the processing circuitry 803 may transmit, via transceiver circuitry 801, the position estimated to the network node 900 or another wireless device UE.

Various operations from the flow chart of FIG. 10 may be optional with respect to some embodiments of wireless devices and related methods. For example, operations of blocks 1000, 1002, 1004, and 1014 of FIG. 10 may be optional.

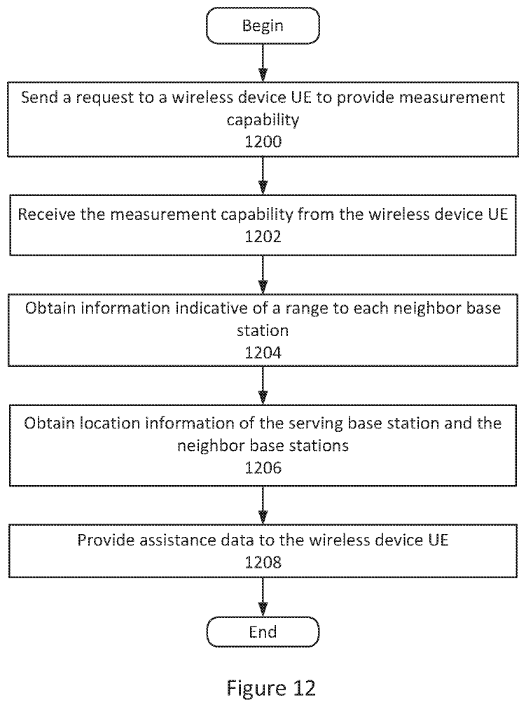

Operations of a network node 900 (implemented using the structure of FIG. 9) will now be discussed with reference to the flow chart of FIG. 12 according to some embodiments of inventive concepts. For example, modules may be stored in memory 905 of FIG. 9, and these modules may provide instructions so that when the instructions of a module are executed by respective node processing circuitry 903, processing circuitry 903 performs respective operations of the flow chart of FIG. 12.

Turning to FIG. 12, in operation 1200, the processing circuitry 903 may send, via transceiver circuitry 901 and/or network interface circuitry 907, a request to a wireless device UE to provide measurement capability of the wireless device UE. In operation 1202, the processing circuitry 903 may receive, via transceiver circuitry 901 and/or network interface circuitry 907, the measurement capability of the wireless device UE from the wireless device UE. For example, the wireless device UE may send what type of RTT measurement is supported from one or more of: serving cell only RTT, asymmetric RTT, symmetric RTT, difference between asymmetric neighbor cell RTT and reference RTT, and difference between symmetric neighbor cell RTT and reference RTT.

In operation 1204, the processing circuitry 903 may obtain, via transceiver circuitry 901 and/or network interface circuitry 907, information indicative of a range to each of one or more neighbor base stations of a serving cell base station of the wireless device UE. This information may include one or more of:
Time of arrival of neighbor cell signal at the serving cell base station,
Time difference of arrival of neighbor cells at the serving cell base station or an offset relative to a reference time (e.g., serving cell base station reference time),
Estimated time of arrival of neighbor cell signal at the wireless device UE,
Time difference of arrival of neighbor cells at the serving cell base station or an offset relative to a reference time (e.g., serving cell time of arrival or subframe/slot/radio frame with a certain index), to be used for E-CID positioning or wireless device UE Rx-Tx measurements or wireless device UE RTT measurements,
Estimated time T0 of arrival of the serving cell signal and a search window (e.g., centered at T0) within which the neighbor cell signals are expected to arrive at the wireless device UE, to be used for E-CID positioning or wireless device UE Rx-Tx measurements or wireless device UE RTT measurements, and/or

In operation 1206, the processing circuitry 903 may obtain, via transceiver circuitry 901 and/or network interface circuitry 907, information about the location of the base station antennas for one or more of the serving cell base station and neighbor base stations.

In operation 1208, the processing circuitry may provide, via transceiver circuitry 901 and/or network interface circuitry 907, assistance data to the wireless device UE 800. The assistance data may be provided to a requesting wireless device UE or be sent to the serving cell base station to broadcast the assistance data to the wireless device UEs that are being served by the serving cell base station.

Example embodiments are discussed below.

Embodiment 1. A method of determining a position of a wireless device user equipment, UE, in the wireless device UE, the method comprising:
obtaining (1006) assistance data from a network node for determining the position of the wireless device UE at the wireless device UE;
performing (1008) an RTT measurement procedure with a serving cell base station;
measuring (1010) a received time of a downlink position reference signal, DL PRS, from one or more neighbor base stations; and
estimating (1012) the position using the assistance data, the RTT measurement procedure and the received time of the DL PRS.
   Embodiment 2. The method of Embodiment 1, further comprising:
providing (1002) measurement capability to the network node of a type of RTT measurement supported by the wireless device UE.
   Embodiment 3. The method of Embodiment 2, wherein providing the measurement capability comprises providing the measurement capability responsive to receiving (1000) a request to provide the measurement capability.
   Embodiment 4. The method of any of Embodiments 1-3, further comprising requesting (1004) assistance data from a network node for determining a position of the wireless device UE.
   Embodiment 5. The method of any of Embodiments 1-4, wherein obtaining the assistance data comprises obtaining the assistance data from one of a location server, the serving cell base station, or a radio resource control, RRC.
   Embodiment 6. The method of any of Embodiments 1-5, further comprising:
transmitting (1014) the position estimated to one of a network node or another wireless device UE.
   Embodiment 7. The method of any of Embodiments 1-6 wherein the assistance data comprises any one or more of: time of arrival of a neighbor cell signal at the serving cell base station of the wireless device UE, time difference of arrival of neighbor cell signals at the serving cell base station or an offset relative to a serving cell base station reference time.
   Embodiment 8. The method of Embodiment 7 wherein the assistance data further comprises information about a position of the serving cell base station and a position of the one or more neighbor base stations

Embodiment 9. The method of Embodiment 8 wherein the assistance data further comprises any one or more of an estimated time of arrival of the neighbor cell signal at the wireless device UE, a time difference of arrival of neighbor cell signals at the serving cell base station or an offset relative to a reference time to be used for E-CID positioning or wireless device UE Rx-Tx measurements or wireless device UE round trip time, RTT, measurement procedures, estimated time T0 of arrival of a serving cell base station signal and a search window within which the neighbor cell signals are expected to arrive at the wireless device UE to be used for E-CID positioning or wireless device UE Rx-Tx measurements or wireless device UE RTT measurement procedures, or.

Embodiment 10. The method of Embodiment 9, wherein the offset relative to a reference time to be used for E-CID positioning comprises a serving cell base station time of arrival.
Embodiment 11. The method of any of Embodiments 9-10, wherein the search window is centered at T0.
Embodiment 12. The method of any of Embodiments 1-7 wherein estimating the position comprises:
obtaining (1100) a position of the serving cell base station and a position of each of the one or more neighbor base stations;
obtaining (1102) a set of received signal measurements from neighbor DL PRS observed from the serving cell base station from the assistance data; and
estimating (1104) the position using the position of the serving cell base station, the position of the one or more neighbor base stations, the set of received signal measurements from neighbor DL PRS observed from the serving cell base station, the RTT measurement procedure with the serving cell base station, and the received time of the DL PRS from the one or more neighbor base stations.
   Embodiment 13. The method of Embodiment 12 wherein estimating the position using the position of the serving cell base station, the position of the one or more neighbor base stations, the set of received signal measurements from neighbor DL PRS observed from the serving cell base station, the RTT measurement procedure with the serving cell base station, and the received time of the DL PRS from the one or more neighbor base stations comprises estimating the position based on:

ds=ts*c=½ RTT*c=½(sRX−sTX)−(suTx−suRx);

dn1=ds1−(suRX−n1uRx)+ds+(sTx−n1bRx); and

dn2=ds2−(suRx−n2uRx)+ds+(sTx−n2bRx),
where c is a speed of light, ts is a time of flight, sRX is a reception time of an uplink signal from the wireless device UE, sTX is a time a downlink PRS signal is transmitted to the wireless device UE, suTX is a time the uplink signal is transmitted from the wireless device UE, suRX is a downlink PRS reception time at the wireless device UE, ds is a distance between the serving cell base station and the wireless device UE, ds1 is a distance between the serving cell base station and a first one of the one or more neighbor base stations, ds2 is a distance between the serving cell base station and a second one of the one or more neighbor base stations, dn1 is a distance between the wireless device UE and the first one of the one or more neighbor base stations, and dn2 is a distance between the wireless device UE and the second one of the one or more neighbor base stations.
   Embodiment 14. The method of Embodiment 12 wherein estimating the position using the position of the serving cell base station, the position of the one or more neighbor base stations, the set of received signal measurements from neighbor DL PRS observed from the serving cell base station, the RTT measurement procedure with the serving cell base station, and the received time of the DL PRS from the one or more neighbor base stations comprises:

ds=ts*c=½RTT*c=c/2((suTX−suRX2)−(sTx2−sRx))=c/2((suTX−suRX2)−(P−(sRx−sTx));

dn1=ds1−(suRX−n1uRx)+ds+(sTx−n1bRx); and

dn2=ds2−(suRx−n2uRx)+ds+(sTx−n2bRx),
where c is a speed of light, ts is a time of flight, sRX is a reception time of an uplink signal from the wireless device UE, sTX is a time a downlink PRS signal is transmitted to the wireless device UE, suTX is a time the uplink signal is transmitted from the wireless device UE, suRX2 is a downlink PRS reception time at the wireless device UE, P is a periodicity of a periodic DL PRS, ds is a distance between the serving cell base station and the wireless device UE, ds1 is a distance between the serving cell base station and a first one of the one or more neighbor base stations, ds2 is a distance between the serving cell base station and a second one of the one or more neighbor base stations, dn1 is a distance between the wireless device UE and the first one of the one or more neighbor base stations, and dn2 is a distance between the wireless device UE and the second one of the one or more neighbor base stations.
   Embodiment 15. A wireless device user equipment, UE, (800) configured to operate in a communication network, the wireless device UE comprising:
processing circuitry (803); and
memory (805) coupled with the processing circuitry, wherein the memory includes instructions that when executed by the processing circuitry causes the wireless device UE to perform operations according to any of Embodiments 1-14.
   Embodiment 16. A wireless device user equipment, UE, (800) configured to operate in a communication network, wherein the wireless device UE is adapted to perform according to any of Embodiments 1-14.
   Embodiment 17. A computer program comprising program code to be executed by processing circuitry (803) of a wireless device user equipment, UE, (800) configured to operate in a communication network, whereby execution of the program code causes the wireless device UE (800) to perform operations according to any of Embodiments 1-14.
   Embodiment 18. A computer program product comprising a non-transitory storage medium including program code to be executed by processing circuitry (803) of a wireless device user equipment, UE, (800) configured to operate in a communication network, whereby execution of the program code causes the wireless device UE (800) to perform operations according to any of Embodiments 1-14.
   Embodiment 19. A method in a network node of providing assistance data to a wireless device user equipment, UE, for the wireless device UE to estimate a position of the wireless device UE, the method comprising:
obtaining (1204) information indicative of a range to each of one or more neighbor base stations of a serving cell base station of the wireless device UE;
obtaining (1206) location information of the serving cell base station and the one or more neighbor base stations;
providing (1208) assistance data to the wireless device UE, the assistance data comprising the information indicative of the range to each of the one or more neighbor base stations and the location information of the serving cell base station and the one or more neighbor base stations.
   Embodiment 20. The method of Embodiment 19, wherein providing the assistance data comprises providing the assistance data responsive to receiving a request to provide the assistance data.
   Embodiment 21. The method of any of Embodiments 19-20, further comprising:
sending (1200) a request to the wireless device UE to provide measurement capability of the wireless device UE; and
receiving (1202) the measurement capability of the wireless device UE.
   Embodiment 22. The method of any of Embodiments 19-21 wherein the information indicative of the range to each of the one or more neighbor base stations comprises any one or more of:
time of arrival of a neighbor cell signal at the serving cell base station; and
time difference of arrival of neighbor cell signals at the serving cell base station or an offset relative to a serving cell base station reference time.
   Embodiment 23. The method of Embodiment 22 wherein the assistance data further comprises any one or more of an estimated time of arrival of the neighbor cell signal at the serving cell base station, a time difference of arrival of neighbor cell signals at the serving cell base station or an offset relative to a reference time to be used for E-CID positioning or wireless device UE Rx-Tx measurements or wireless device UE round trip time, RTT, measurements, estimated time T0 of arrival of a serving cell base station signal and a search window within which the neighbor cell signals are expected to arrive at the wireless device UE to be used for E-CID positioning or wireless device UE Rx-Tx measurements or wireless device UE RTT measurement procedures.
   Embodiment 24. The method of any of Embodiments 19-23, further comprising:

initiating a serving cell round trip time procedure with the wireless device UE.

Embodiment 25. The method of any of Embodiments 19-24, further comprising:
configuring one of wireless device UE RTT or wireless device UE Rx-Tx measurement.
   Embodiment 26. The method of any of Embodiments 19-25, further comprising transmitting the assistance data to the serving cell base station of the wireless device UE for broadcast to other wireless devices served by the serving cell base station.
   Embodiment 27. A network node (900) configured to operate in a communication network, the wireless device UE comprising:
processing circuitry (903); and
memory (905) coupled with the processing circuitry, wherein the memory includes instructions that when executed by the processing circuitry causes the network node (900) to perform operations according to any of Embodiments 18-26.
   Embodiment 28. A network node (900) configured to operate in a communication network, wherein the network node (900) is adapted to perform according to any of Embodiments 18-26.
   Embodiment 29. A computer program comprising program code to be executed by processing circuitry (903) of a network node (900) configured to operate in a communication network, whereby execution of the program code causes the network node (900) to perform operations according to any of Embodiments 18-26.
   Embodiment 30. A computer program product comprising a non-transitory storage medium including program code to be executed by processing circuitry (903) of a network node (900) configured to operate in a communication network, whereby execution of the program code causes the network node (900) to perform operations according to any of Embodiments 18-26.

Explanations are provided below for various abbreviations/acronyms used in the present disclosure.

| Abbreviation | Explanation |
|---|---|
| BS | Base Station |
| CSI-RS | Channel State Information Reference Signal |
| DL | Down Link |
| DM-RS | Demodulation Reference Signal |
| NR | New Radio |
| OTDOA | Observed Time Difference of Arrival |
| PDP | Power Delay Profile |
| LMF | Location Management Function |
| LOS | Line of Sight |
| LPP | LTE Positioning Protocol |
| MAC | Medium Access Control |
| NLOS | Non-Line of Sight |
| NRPPa | New Radio Positioning Protocol A |
| NW | Network |
| PDP | Power Delay Profile |
| PRACH | Physical Random Access Channel |
| PRS | Positioning Reference Signal |
| RTT | Round Trip Time |
| RSRP | Reference Signal Received Power |
| Rx-Tx | Receive-Transmit |
| SRS | Sounding Reference Signal |
| SSB | Synchronization Signal Block |
| TDOA | Time Difference of Arrival |
| ToA | Time of Arrival |
| TRS | Tracking Reference Signal |
| UE | User Equipment |
| UL | Up Link |

References are identified below.
1. R1-1901197, 3GPP TSG RAN WG1 Ad-Hoc Meeting 1901, titled “On the use of RTT for positioning”, Taepei, Taiwan, Jan. 21-25, 2019.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 13 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4190 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 13 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE) or wireless device UE. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4112 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

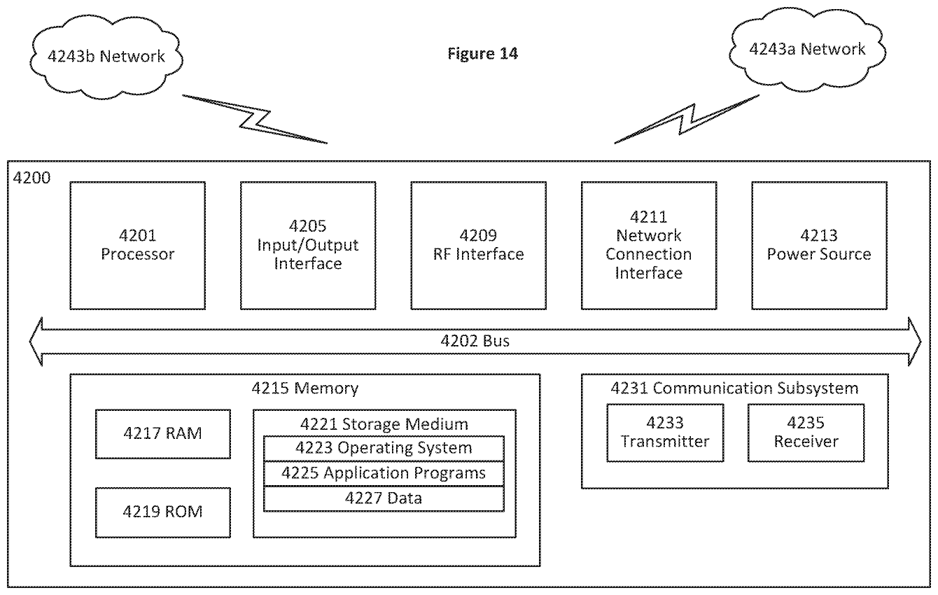

FIG. 14 illustrates a user Equipment in accordance with some embodiments.

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-IoT UE, a machine type communication (MTC) UE, and/or an enhanced MTC (eMTC) UE. UE 4200, as illustrated in FIG. 14, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4233, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 14, processing circuitry 4201 may be configured to communicate with network 4243b using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

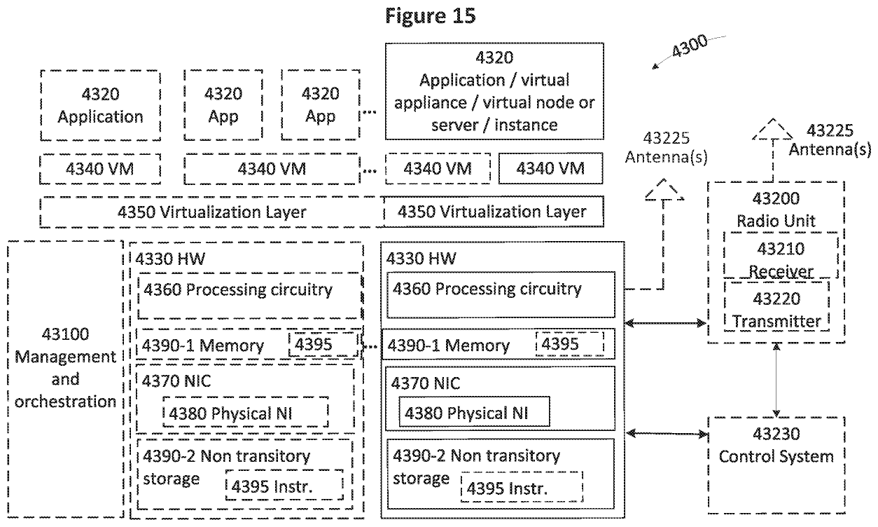

FIG. 15 illustrates a virtualization environment in accordance with some embodiments.

FIG. 15 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340, comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 15, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 15.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

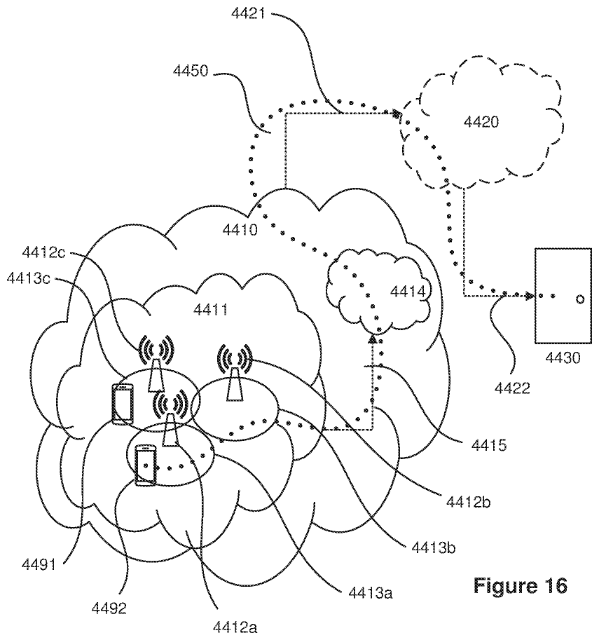

FIG. 16 illustrates a telecommunication network connected via an intermediate network to a host computer in accordance with some embodiments.

With reference to FIG. 16, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 16 as a whole enables connectivity between the connected UEs 4491, 4492 and host computer 4430. The connectivity may be described as an over-the-top (OTT) connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

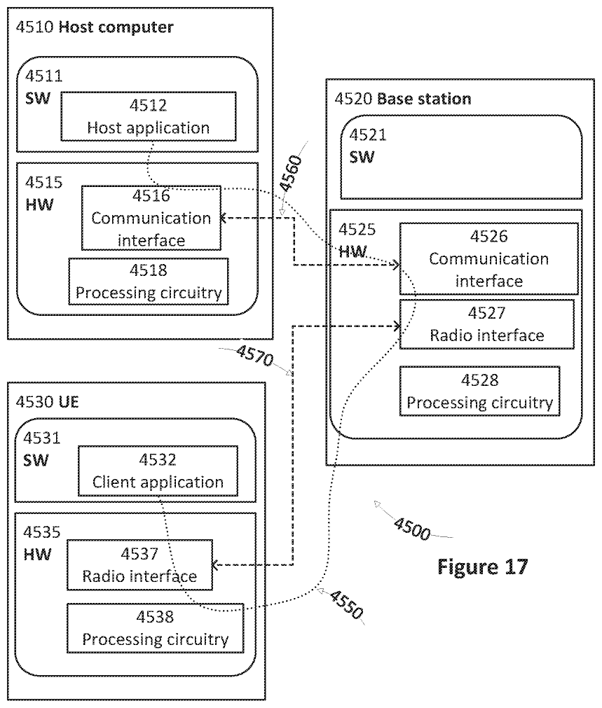

FIG. 17 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 17. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities. In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 17) served by base station 4520. Communication interface 4526 may be configured to facilitate connection 4560 to host computer 4510. Connection 4560 may be direct or it may pass through a core network (not shown in FIG. 17) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

It is noted that host computer 4510, base station 4520 and UE 4530 illustrated in FIG. 17 may be similar or identical to host computer 4430, one of base stations 4412a, 4412b, 4412c and one of UEs 4491, 4492 of FIG. 16, respectively. This is to say, the inner workings of these entities may be as shown in FIG. 17 and independently, the surrounding network topology may be that of FIG. 16.

In FIG. 17, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors etc.

FIG. 18 illustrates methods implemented in a communication system including a host computer, a base station and a user equipment in accordance with some embodiments

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

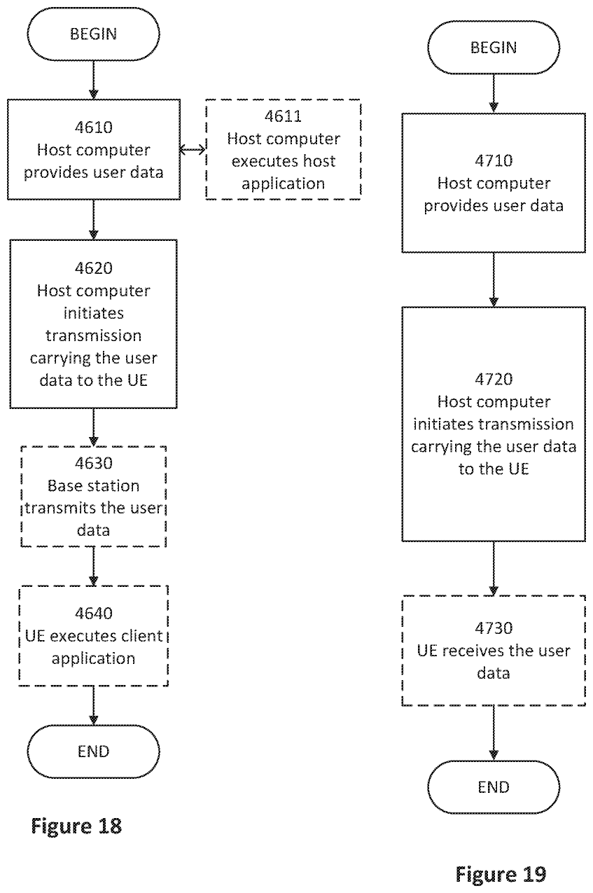

FIG. 19 illustrates methods implemented in a communication system including a host computer, a base station and a user equipment in accordance with some embodiments.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

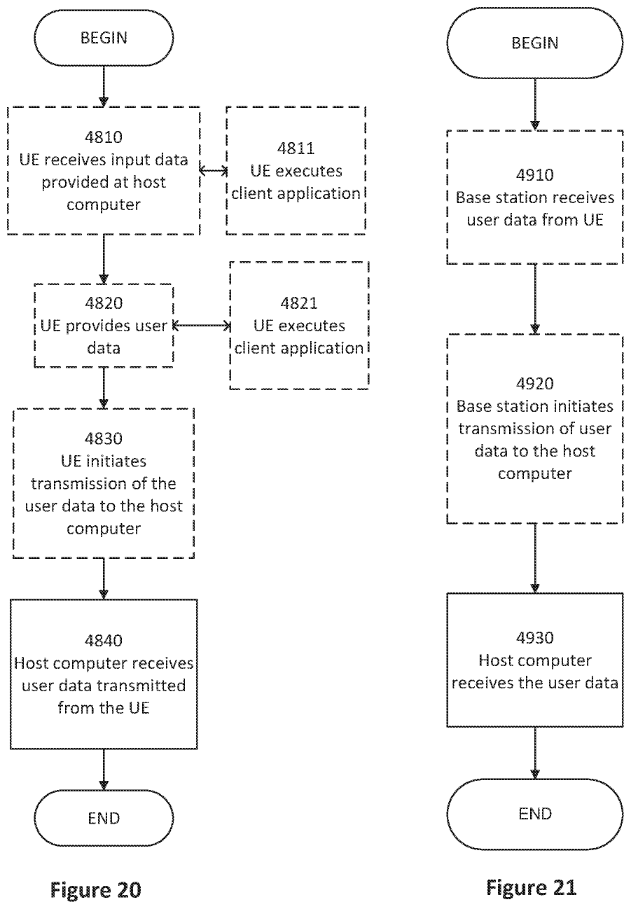

FIG. 20 illustrates methods implemented in a communication system including a host computer, a base station and a user equipment in accordance with some embodiments

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

FIG. 21 illustrates methods implemented in a communication system including a host computer, a base station and a user equipment in accordance with some embodiments

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Abbreviations

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 1× RTT | CDMA2000 1× Radio Transmission Technology |
| 3GPP | 3rd Generation Partnership Project |
| 5G | 5th Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH | Ec/No CPICH Received energy per chip |
| | divided by the power density in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| E-SMLC | Evolved-Serving Mobile Location Centre |
| ECGI | Evolved CGI |
| eNB | E-UTRAN NodeB |
| ePDCCH | enhanced Physical Downlink Control Channel |
| E-SMLC | evolved Serving Mobile Location Center |
| E-UTRA | Evolved UTRA |
| E-UTRAN | Evolved UTRAN |
| FDD | Frequency Division Duplex |
| FFS | For Further Study |
| GERAN | GSM EDGE Radio Access Network |
| gNB | Base station in NR |
| GNSS | Global Navigation Satellite System |
| GSM | Global System for Mobile communication |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning Protocol |
| LTE | Long-Term Evolution |
| MAC | Medium Access Control |
| MBMS | Multimedia Broadcast Multicast Services |
| MBSFN | Multimedia Broadcast multicast service Single Frequency |
| | Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDP | Profile Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| UMTS | Universal Mobile Telecommunication System |
| USIM | Universal Subscriber Identity Module |
| UTDOA | Uplink Time Difference of Arrival |
| UTRA | Universal Terrestrial Radio Access |
| UTRAN | Universal Terrestrial Radio Access Network |
| WCDMA | Wide CDMA |
| WLAN | Wide Local Area Network |

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of determining a position of a user equipment, UE,
performed by the UE, the method comprising:
obtaining assistance data from a network node for determining the position of the UE at the UE;
performing a round trip time, RTT, measurement procedure with a serving cell base station to obtain a RTT measurement;
measuring a received time of a downlink position reference signal, DL PRS, from one or more neighbor base stations; and
estimating the position using the assistance data, the RTT measurement and the received time of the DL PRS.

2. The method of claim 1, further comprising:
providing measurement capability to the network node of a type of RTT measurement supported by the UE.

3. The method of claim 1, further comprising requesting the assistance data from a network node for determining a position of the wireless device UE.

4. The method of claim 1, wherein obtaining the assistance data from the network node comprises obtaining the assistance data from one of a location server, the serving cell base station, or a core network node.

5. The method of claim 1, wherein the assistance data comprises any one or more of: time of arrival of a neighbor cell signal at the serving cell base station of the wireless device UE, time difference of arrival of neighbor cell signals at the serving cell base station, or an offset relative to a serving cell base station reference time.

6. The method of claim 5, wherein the assistance data further comprises information about a position of the serving cell base station and a position of the one or more neighbor base stations.

7. The method of claim 6, wherein the assistance data further comprises any one or more of an estimated time of arrival of the neighbor cell signal at the UE, a time difference of arrival of neighbor cell signals at the serving cell base station or an offset relative to a reference time to be used for multiCell RTT, positioning or UE receive-transmit, Rx-Tx, measurements or UE RTT measurement procedures, estimated time T0 of arrival of a serving cell base station signal and a search window within which the neighbor cell signals are expected to arrive at the UE to be used for multiCell RTT positioning or UE Rx-Tx measurements or UE RTT measurement procedures.

8. The method of claim 7, wherein the offset relative to a reference time to be used for RTT based positioning comprises a serving cell base station time of arrival.

9. (canceled)

10. The method of claim 5, wherein estimating the position comprises:
obtaining a position of the serving cell base station and a position of each of the one or more neighbor base stations;
obtaining a set of received signal measurements from neighbor DL PRS observed from the serving cell base station from the assistance data; and
estimating the position using the position of the serving cell base station, the position of the one or more neighbor base stations, the set of received signal measurements from neighbor DL PRS observed from the serving cell base station, the RTT measurement with the serving cell base station, and the received time of the DL PRS from the one or more neighbor base stations.

11. The method of claim 10, wherein estimating the position using the position of the serving cell base station, the position of the one or more neighbor base stations, the set of received signal measurements from neighbor DL PRS observed from the serving cell base station, the RTT measurement with the serving cell base station, and the received time of the DL PRS from the one or more neighbor base stations comprises estimating the position based on:
ds=ts*c=½RTT*c=½(sRX−sTX)−(suTx−suRx);
dn1=ds1−(suRX−n1uRx)+ds+(sRX−n1bRx); and
dn2=ds2−(sRX−n2uRx)+ds+(sRX−n1bRx),
where c is a speed of light, is a time of flight, sRX is a reception time of an uplink signal from the UE, sTX is a time a downlink PRS signal is transmitted to the wireless device UE, suTX is a time the uplink signal is transmitted from the wireless device UE, suRX is a downlink PRS reception time at the UE, ds is a distance between the serving cell base station and the UE, ds1 is a distance between the serving cell base station and a first one of the one or more neighbor base stations, ds2 is a distance between the serving cell base station and a second one of the one or more neighbor base stations, dn1 is a distance between the wireless device UE and the first one of the one or more neighbor base stations, and dn2 is a distance between the wireless device UE and the second one of the one or more neighbor base stations.

12. The method of claim 10, wherein estimating the position using the position of the serving cell base station, the position of the one or more neighbor base stations, the set of received signal measurements from neighbor DL PRS observed from the serving cell base station, the RTT measurement with the serving cell base station, and the received time of the DL PRS from the one or more neighbor base stations comprises:
ds=ts*c=½RTT*c=c/2((suTX−suRX2)−(sTx2−sRx))=c/2((suTX−suRX2)−(P−(sRX−sTX));
dn1=ds1−(suRX−n1uRx)+ds+(sTx−n1bRx); and
dn2=ds2−(suRX−n2uRx)+ds+(sTx−n2bRx),
where c is a speed of light, ts is a time of flight, sRX is a reception time of an uplink signal from the UE, sTX is a time a downlink PRS signal is transmitted to the UE, suTX is a time the uplink signal is transmitted from the wireless device UE, suRX2 is a downlink PRS reception time at the UE, P is a periodicity of a periodic DL PRS, ds is a distance between the serving cell base station and the UE, ds1 is a distance between the serving cell base station and a first one of the one or more neighbor base stations, ds2 is a distance between the serving cell base station and a second one of the one or more neighbor base stations, dn1 is a distance between the UE and the first one of the one or more neighbor base stations, and dn2 is a distance between the UE and the second one of the one or more neighbor base stations.

13. A user equipment, UE, configured to operate in a communication network, the UE comprising:
processing circuitry; and
memory coupled with the processing circuitry, wherein the memory includes instructions that when executed by the processing circuitry causes the UE to perform operations comprising:
obtaining assistance data from a network node for determining the position of the UE at the UE;
performing a round trip time, RTT, measurement procedure with a serving cell base station to obtain a RTT measurement;
measuring a received time of a downlink position reference signal, DL PRS, from one or more neighbor base stations; and
estimating the position using the assistance data, the RTT measurement and the received time of the DL PRS.

14. The UE of claim 13, wherein the memory includes further instructions that when executed by the processing circuitry causes the UE to perform operations further comprising:
providing measurement capability to the network node of a type of RTT measurement supported by the UE.

15. The UE of claim 13, wherein the memory includes further instructions that when executed by the processing circuitry causes the UE to perform operations further comprising requesting the assistance data from a network node for determining a position of the wireless device UE.

16. The UE of claim 13, wherein obtaining the assistance data from the network node comprises obtaining the assistance data from one of a location server, the serving cell base station, or a core network node.

17-25. (canceled)

26. A method in a network node of providing assistance data to a user equipment, UE, for the UE to estimate a position of the UE, the method comprising:
obtaining information indicative of a distance to each of one or more neighbor base stations of a serving cell base station of the UE;
obtaining location information of the serving cell base station and the one or more neighbor base stations;
providing assistance data to the UE, the assistance data comprising the information indicative of the distance to each of the one or more neighbor base stations and the location information of the serving cell base station and the one or more neighbor base stations.

27. (canceled)

28. The method of claim 26, further comprising:
sending a request to the UE to provide measurement capability of the UE; and
receiving the measurement capability of the UE.

29. The method of claim 26 wherein the information indicative of the range to each of the one or more neighbor base stations comprises any one or more of:
time of arrival of a neighbor cell signal at the serving cell base station; and
time difference of arrival of neighbor cell signals at the serving cell base station or an offset relative to a serving cell base station reference time.

30. The method of claim 29, wherein the assistance data further comprises any one or more of an estimated time of arrival of the neighbor cell signal at the serving cell base station, a time difference of arrival of neighbor cell signals at the serving cell base station or an offset relative to a reference time to be used for multicell-RTT, positioning or wireless device UE receive-transmit, Rx-Tx, measurements or wireless device UE round trip time, RTT, measurements, estimated time T0 of arrival of a serving cell base station signal and a search window within which the neighbor cell signals are expected to arrive at the wireless device UE to be used for multicell-RTT positioning or wireless device UE Rx-Tx measurements or wireless device UE RTT measurement procedures.

31-39. (canceled)

40. A network node configured to operate in a communication network, wherein the network node is adapted to perform according to claim 26.
